(19) United States
(12) Patent Application Publication
(10) Pub. No.: US 2005/0050261 A1
(43) Pub. Date: Mar. 3, 2005

(54) High density flash memory with high speed cache data interface

(76) Inventors: Thomas Roehr, Kanagawa-ken (JP); Michael Jacob, Kanagawa-ken (JP); Nobert Rehm, Kanagawa-ken (JP); Hans-Oliver Joachim, Kanagawa-ken (JP)

Correspondence Address: FISH & RICHARDSON, PC, 12390 EL CAMINO REAL, SAN DIEGO, CA, 92130-2081, US

(21) Appl. No.: 10/650,458

(22) Filed: Aug. 27, 2003

(51) Int. Cl. G06F 12/00

(52) U.S. Cl. 711/103; 711/165

(57) ABSTRACT

A data storage device comprises a controller, a FeRAM memory unit, and a flash memory unit having a much higher data storage capacity than the FeRAM memory unit. Initially, when data is received by the data storage device, the controller stores it in the FeRAM memory unit. This can be done very quickly, since FeRAM devices have a high write rate. Subsequently, the controller transfers the data to the flash memory unit. Thus, the data storage device combines the high storage rate ability of FeRAM devices and the high storage capacity of flash memory devices.

### FIELD OF THE INVENTION

The present invention relates to a data storage device, of the sort providing non-volatile data storage.

### BACKGROUND OF INVENTION

Flash memory (also known as FEPROM, “flash erasable read-only memory”) is a well established technology. It is defined as a type of EPROM (erasable programmable read-only memory) in which erasing can only be done in blocks of the memory or over the entire memory chip, and in which erasing can be done with the chip installed in a computer system. Currently available flash memory chips provide a very high memory density (e.g. 512 Mbit, or even more). Reading data from such a memory is reasonably fast, but writing it is a slow operation due to the storage principle of flash memory. Typically, a data write operation takes of the order of milliseconds or more.

By contrast, the newer technology of FeRAM (ferroelectric random access memory) provides a non-volatile RAM memory having a much faster write performance with write access times in the range 50 ns and below. However, currently FeRAM technology only allows limited memory densities, below 1 Mbit (although it is envisaged that densities in the range 32 Mbit will soon be commercially available at reasonable cost).

### SUMMARY OF THE INVENTION

The present invention aims to provide a new and useful non-volatile data storage device, and in particular one having high storage capacity (over 100 Mbits) and fast write times.

In general terms, the invention proposes a data storage device in which a first non-volatile memory unit is used as a data cache into which data is temporarily written, and a second non-volatile memory (having a storage capacity of 100 Mbit or higher) is used as a main memory. The first non-volatile memory unit supports a higher rate of data write than the second non-volatile memory unit. Data may be written at high rates into the first non-volatile memory, and then gradually transferred into the second non-volatile memory. Thus, the device can provide both high speed data writing and high storage capacity. Since both of the memories are non-volatile, no data loss results from any unexpected power-down of the system.

The first non-volatile memory unit is preferably an FeRAM memory, or may alternatively be an MRAM memory.

The second non-volatile memory is preferably a flash memory, but may alternately be any other high density memory which is used to store charge to change the characteristics of a storage device (e.g. a transistor), which is programmed by forcing an electrical charge on a floating storage gate (EEPROM, FLASH) or into a gate dielectric (NROM). During read the characteristics of the storage device (e.g. its threshold voltage) depends on the amount of charge which was stored. Read operation for such devices is fast, but write operations are relatively slow as the charge tunnelling processes are slow.

### BRIEF DESCRIPTION OF THE FIGURES

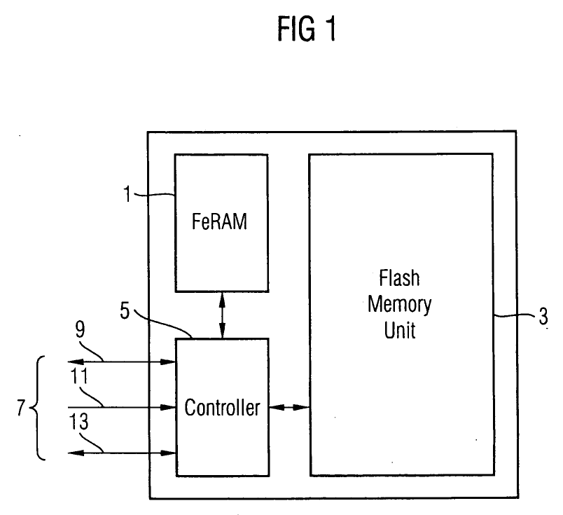

Preferred features of the invention will now be described, for the sake of illustration only, with reference to FIG. 1, which shows schematically an embodiment of the invention

### DETAILED DESCRIPTION OF THE EMBODIMENTS

As illustrated in FIG. 1, the memory device which is an embodiment of the present invention comprises an FeRAM unit 1, a flash memory unit 3 and a controller 5. The FeRAM unit 1 has a storage capacity less than that of the flash memory unit 5. Typically, the storage capacity of the FeRAM unit 1 is above 1 Mbit, such as 4 Mbit, while the storage capacity of the flash memory unit 3 is above 100 Mbit, such as 128 Mbit.

The device has an interface 7 (implemented by multiple lead pins) including a data I/O interface 9 for receiving data to be stored in the memory device and transmitting data retrieved from the memory device, an address interface 11 for receiving signals indicative of the address at which the data is to be stored, and a control signal interface 13 for receiving control signals: a “write signal”0 which indicates that data received at the data I/O interface 9 is to be stored at an address indicated by the address received at the address interface 11; or a “read signal” indicating that data stored at an address received at the address interface 11 is to be transmitted through the data I/O interface 9.

The controller 5 controls the operation of the FeRAM unit 1 and flash memory unit 3. Initially (i.e. at a time when the FeRAM unit 1 is not full) the controller 5 stores data received through the data interface 9 in the FeRAM unit 1. Thus, data can be written to the memory device at a speed typical of an FeRAM memory, provided that the data received during this period is not greater than the capacity of the FeRAM unit 1. Subsequently, the controller 5 transfers the data from the FeRAM unit 1 to the flash memory unit 3, gradually emptying the FeRAM device. Thus, the FeRAM unit 1 acts as a data cache, for temporary data storage. Usually the data is not actually erased from the FeRAM unit 1, but instead it remains there until it is later overwritten, when new data arrives.

Note that addresses supplied to the address interface 11 indicate addresses in the flash memory unit 3. They do not indicate a specific addresses in the FeRAM unit 1. As in conventional cache memories, the FeRAM unit 1 stores the data in combination with the address data, so that subsequently the controller 3 can copy the data to the correct position in the flash memory unit 3. The data itself depends on the addressing technique. For sequential addresses, the starting and end addresses only are sufficient, whereas for random access the address for each data word has to be stored.

When the controller 5 receives a read control signal, if there is no data in the FeRAM unit 1 at that time, the controller 5 extracts the data directly from the location in the flash memory unit 3 corresponding to the address specified at the address interface 11, and transmits that data through the data interface 9. In the case that there is still some data in the FeRAM unit 1 at this time, this process is supplemented by a step in which the controller checks that the requested data is not in the FeRAM, and if it is transmits it out of the device. This read operation can be performed quickly, without making use of the FeRAM unit 1 because read operations from a flash memory are fast.

Therefore, the above scheme provides both high memory density and fast read and write operations.

One problems arises if storage capacity of the FeRAM memory unit 1 is exceeded, i.e. if the data written to the device during a short period exceeds the ability of the controller 5 to write it to the flash memory unit 3 by more than the capacity of the FeRAM memory unit 1. Provided that the capacity of the FeRAM device is higher than the amount of data which is transmitted to the memory device during typical single write operations, this contingency should be rare. If it occurs, the memory device may simply not perform the write operation (and optionally may generate a signal which is transmitted from the memory device to indicate that it is not capable of receiving data, e.g. through the control signal interface 13). Alternatively, the controller 5 may transmit any data which cannot be stored in the FeRAM memory unit 1 directly to the flash memory unit 3. In this case, the write operation will be performed, albeit at the write speed associated with presently known flash memory devices.

The memory device of the embodiment may be realised in several ways. Most conveniently, the FeRAM memory unit 1, flash memory unit 3 and controller 5 are three separate integrated circuits, but these three integrated circuits may be packaged together in a single package (i.e. to form a one-piece element, e.g. to mount on a printed circuit board), or alternatively may be packaged individually (i.e. as multiple separate elements, e.g. to be mounted separately on a printed circuit board). Any combination of these two packaging possibilities is also possible. Another possibilities is for any one or more of the FeRAM memory unit 1, flash memory unit 3 and controller 5 to be provided on the same wafer, e.g. as embedded technology or system on chip.

Although only a single embodiment of the invention has been described in detail, many variations are possible within the scope of the invention, as will be clear to a skilled reader. For example, whereas the controller 5 can be implemented straightforwardly by a skilled reader making use of the control circuitry which is already present in conventional FeRAM units and flash memory units, in other embodiments the two forms of control can be integrated to some degree, e.g. by providing the functionality of the control unit 5 as a part of the circuitry within the integrated circuit which provides the FeRAM memory unit 1.

Although only a single embodiment of the invention has been described in detail above, various modifications are possible within the scope of the invention as will be clear to a skilled reader. For example, the FeRAM memory unit 1 may be replaced by an MRAM unit. MRAM has higher access performance than FeRAM and its implementation in the present invention could be fundamentally as described above.

1. A data storage device comprising a controller, a first non-volatile memory unit, a second non-volatile memory unit, and a data interface, the controller being arranged upon the device receiving through the data interface data for storage, to store the data in the first non-volatile memory unit, and subsequently to transfer the data to the flash memory unit.

2. A data storage device according to claim 1 in which the first non-volatile memory unit is an FeRAM memory unit.

3. A data storage device according to claim 1 in which the first non-volatile memory unit is an MRAM memory unit.

4. A data storage device according to claim 1 in which the second non-volatile memory unit is a flash memory unit.

5. A data storage device according to claim 1 which is arranged, upon receiving data for storage, to determine whether the first non-volatile memory unit has available unused capacity to store the data, and, upon the determination being negative, to discard the data.

6. A data storage device according to claim 1 which is arranged, upon receiving data for storage, to determine whether the first non-volatile memory unit has available unused capacity to store the data, and, upon the determination being negative, to store the data directly in the second non-volatile memory unit.

7. A data storage device according to claim 1 in which the controller is arranged, in response to a read signal, to extract data from the second non-volatile memory unit and transmit it out of the data storage device.

8. A data storage device according to claim 1 in which the first non-volatile memory unit, controller and second non-volatile memory unit are provided by different integrated circuit elements, and the integrated circuit elements are packaged together to form a one-piece unit.
